(19) United States
(12) Patent Application Publication
(10) Pub. No.: US 2004/0051390 A1
(43) Pub. Date: Mar. 18, 2004

(54) Accessory identification circuit

(76) Inventors: Chason Allan Carroll, Dacula, GA (US); Wayne Anderson, Dacula, GA (US)

Correspondence Address: Motorola Energy Systems Group, Law Department - attn: Zilla Higgs, 1700 Belle Meade Court, Lawrenceville, GA, 30043, US

(21) Appl. No.: 10/235,047

(22) Filed: Sep. 4, 2002

(51) Int. Cl. H02J 1/00; H02J 3/00

(52) U.S. Cl. 307/85

(57) ABSTRACT

This invention includes a circuit that alerts an electronic device as to what type of accessory is connected thereto. For example, with respect to cellular phones, some accessories source power and others sink power. The phone must adjust its circuitry accordingly. The circuit includes a two-pin output, with one output being actuated by a power sourcing accessory and the other providing an interrupt sequence to let the device know that an accessory has been coupled or decoupled. The circuit employs a one-shot trigger to generate the interrupt sequence.

### BACKGROUND

1. Technical Field

This invention relates generally to accessories for portable electronic devices, and more particularly to an initialization circuit to place a portable electronic device in the proper power utilization mode.

2. Background Art

Portable electronic devices are growing ever more popular. By way of example, today it seems everyone has a cellular phone. Manufacturers of cellular phones are now incorporating more and more features into each phone. For example, the next generation of cellular phones manufactured by Motorola will soon include numerous audio accessories, including a hands free car kit and a clip-on speaker phone.

One problem associated with designing a phone that has all of these accessories involves power consumption. In the clip-on speakerphone mode, power for the speakerphone module comes from the battery. In other words, when the speakerphone accessory is connected to the phone, the speakerphone accessory receives power from the phone's battery. By contrast, when a hands free car kit, which generally includes a cigarette lighter adapter, is coupled to the phone, power is delivered to the phone from the car kit. Effectively, while both the clip-on speakerphone and car kit allow a person to use the phone without holding it to his ear, in the former power flows from the phone, while in the latter power flows to the phone.

All of the power flow mentioned above occurs through the same connector. Consequently, to accommodate such accessories, the phone must know whether it is to receive or deliver power. There is thus a need for a circuit to alert the phone of the power delivery mode associated with a given accessory.

### BRIEF DESCRIPTION OF THE DRAWINGS

FIG. 1 is one preferred embodiment in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

Roughly stated, this invention is intended to identify a power delivery mode associated with a particular accessory. This is accomplished by detecting the type of power source and adjusting communication signals to make the appropriate connections within a host electronic device. In doing so, the invention allows a user to move from, for example, a power-sourcing accessory to a power-sinking accessory without having to remove, change, disengage or disrupt the host device.

The three most popular types of accessories for electronic devices include vehicular accessories (which deliver power from a 12V DC system), grid-based accessories (which deliver power from a 120V AC system) and passive accessories (which receive power from a host). For phones that have the capability for multiple accessories, the general default state is the passive accessory mode (i.e. the host device supplies power to the accessory).

Toggling between modes is accomplished through a multi-pin connector coupled to the electronic device. Generally one to three pins are dedicated to accessory identification. These pins are typically digital inputs with CMOS-type logic high and logic low states. Essentially, the host device must know whether a power sourcing accessory (which includes vehicular and grid-based accessories) or a passive accessory is attached. This information may be coupled through a single pin with a simple high or low state.

While a single-pin, binary system works well for some applications, it is often advantageous to include a second input pin as well. The second input pin allows the host device to determine not only what type of accessory is coupled, but also whether it has been attached or detached. It is this two-pin operation that provides the designer with the most flexibility in designing for maximum power conservation.

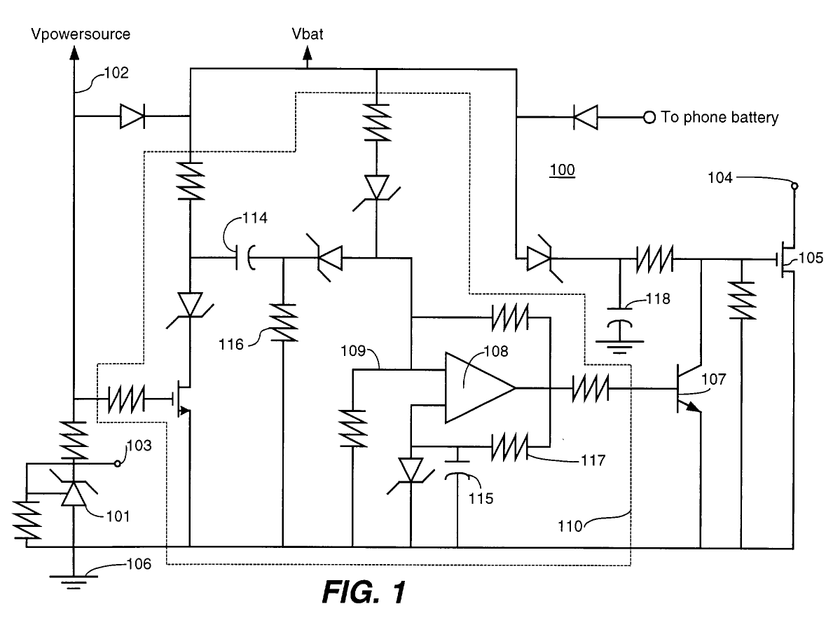

Referring now to FIG. 1, illustrated therein is one preferred embodiment of a two-pin accessory identification circuit 100 in accordance with the invention. A power source detection signal 103 actuates when an external power source is coupled to the power source input 102. In this exemplary embodiment, this detection is accomplished by way of a voltage regulator 101. One example of such a voltage regulator 101 is the TL431 manufactured by Motorola. When power is applied to the power source input 102, the voltage regulator 101 regulates to a predetermined voltage, causing the power source detection signal 103 to go active high. The power source detection signal 103 is coupled to the host device. Through this high-low signal, the host device knows whether a power source is coupled thereto.

The host device learns whether the power source has been coupled or decoupled by way of an attachment signal 104. The attachment signal 104 uses an “interrupt” sequence to alert the host device that a transition event has occurred. An interrupt sequence is an identifier that switches from, for example, low to high and then back to low after a predetermined time.

Referring again to FIG. 1, a junction field effect transistor (JFET) transistor 105 is used to control the attachment signal 104. The JFET 105 is preferable because such transistors are normally in a closed, or shorted state, causing the attachment signal 104 to be pulled active low to ground 105. Once power is applied to the power source input 102, a bipolar junction transistor (BJT) 107 will generally continue to keep JFET 105 closed, as the output 113 of op-amp 108 is normally logic high with power applied by way of input 109.

A one-shot circuit 110 provides the interrupt sequence at the attachment signal 104. One-shot circuits are known in the art, although this specific application is best explained by way of example. Application of power to the power source input 102 causes initial transistor 111 to short to ground, thereby causing filtered node 112 to go low. This, in turn, causes the output 113 of op-amp 108 to go low, causing the attachment signal to briefly pulse high. Capacitors 114 and 115, in conjunction with resistors 116 and 117, respectively, may be varied to change the duration of the one shot pulse. A preferred logic-high duration is about 1 second.

Thus, when an accessory capable of supplying power is coupled to the circuit 100, the power source signal 103 goes high. The one-shot circuit 110 then causes the attachment signal 104 to temporarily pulse high (i.e., generate an interrupt sequence), thereby alerting the host device that a power-supplying accessory has just been attached.

The system works in the same way when the accessory is detached. The power source signal 103 goes low. The one-shot becomes deactivated, but stored energy on capacitor 118 causes an interrupt pulse to the attachment signal 104. Thus, when the power source signal 103 is low and the interrupt sequence appears at the attachment signal 104, the host device knows that the power-sourcing accessory has been removed.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, the host device may be selected from the group consisting of cellular telephones, pagers, computers, personal digital assistants, MP3 players, radios, CD players, and the like.

What is claimed is:

1. A circuit for identifying an accessory, comprising:
a. a first node capable of detecting the presence of an external power source; and
b. a second node capable of generating an interrupt sequence when the external power source is either coupled or decoupled to the circuit.

2. The circuit of claim 1, wherein the second signal capable of generating an input comprises:
a. a one-shot circuit coupled to the second node; and
b. a capacitor coupled in parallel with the one-shot circuit.

3. The circuit of claim 2, further comprising a power source input.

4. The circuit of claim 3, wherein when an external power source is coupled to the power source input, a voltage at the first node transitions from a first state to a second state.

5. The circuit of claim 4, wherein when the external power source is decoupled from the power source input, the voltage at the first node transitions from a second state to a first state.

6. The circuit of claim 5, wherein when the external power source is either coupled to or decoupled from the power source input, an interrupt sequence appears at the second node.

7. The circuit of claim 6, wherein the one-shot circuit comprises:
a. at least one comparator;
b. at least one transistor; and
c. at least one capacitor.

8. The circuit of claim 7, wherein the circuit is coupled to a host device is selected from the group consisting of cellular telephones, pagers, computers, personal digital assistants, MP3 players, radios, and CD players.
